(19) United States
(12) Patent Application Publication
(10) Pub. No.: US 2021/0266765 A1
(43) Pub. Date: Aug. 26, 2021

(54) METHOD AND APPARATUS FOR RAN EVENT REPORT TRANSMISSION AND NETWORK OPTIMIZATION BASED ON ANALYTICS OF RAN EVENT REPORTS

(71) Applicant: LENOVO (BEIJING) LIMITED, Beijing (CN)

(72) Inventors: Zhuoyun Zhang, Beijing (CN); Chenxi Zhu, Fairfax, VA (US); Lianhai Wu, Beijing (CN); Genadi Velev, Darmstadt (DE)

(21) Appl. No.: 17/256,696

(22) PCT Filed: Jun. 29, 2018
(86) PCT No.: PCT/CN2018/093679

§ 371 Date: Dec. 29, 2020

(51) Int. Cl. H04W 24/02; H04W 24/10; H04W 24/04; H04W 68/02

(52) U.S. Cl. CPC H04W 24/02; H04W 68/02; H04W 24/04; H04W 24/10

(57) ABSTRACT

The present application is directed to a method and apparatus for RAN event report transmission and network optimization based on analytics of RAN event reports. According to an embodiment of the present application, a method includes sending an event report subscription to a radio access network node, receiving a report of an event associated with the event report subscription from the radio access network node, and transmitting the received report to a network data analytics function. This method can be implemented in a network function in a core network, for example, an access management function or a RAN event collection function.

### TECHNICAL FIELD

Embodiments of the present application generally relate to new generation wireless communication technology, and more specifically to RAN (radio access network) event report mechanism and network optimization based on the analytics of RAN event reports.

### BACKGROUND OF THE INVENTION

In 3GPP (3rd Generation Partnership Project) SA2 #121 meeting, a new study item “Study of Enablers for Network Automation for 5G” was approved. This study item is directed to solutions involving NWDAF (network data analytics function) in order to realize network automation deployment, and one of the solutions is related to network optimization based on paging failure report.

However, one obstacle of the network optimization solution is how to report RAN event to the NWDAF if there is no direct interface between a RAN node and the NWDAF.

Thus, technical solutions for RAN event report transmission between RAN nodes and the NWDAF and network optimization based on the analytics of RAN event reports are desired for the industry.

### BRIEF SUMMARY OF EMBODIMENTS OF THE INVENTION

One objective of the embodiments of the present application is to provide a technical solution for RAN event report transmission between RAN nodes and NWDAF.

Another objective of the embodiments of the present application is to provide a technical solution for network optimization based on analytics of RAN event reports.

An embodiment of the present application provides a method including: sending an event report subscription to a radio access network node, receiving a report of an event associated with the event report subscription from the radio access network node, and transmitting the received report to a network data analytics function.

Another embodiment of the present application provides an apparatus, which includes: at least one transmitter and at least one receiver. The at least one transmitter and the at least one receiver are configured to: send an event report subscription to a radio access network node via the at least one transmitter, receive a report of an event in response to the event report subscription from the radio access network node via the at least one receiver, and transmit the received report to a network data analytics function via the at least one transmitter.

In an embodiment of the present application, a method includes: sending an event subscription for subscribing event reports from a radio access network node to a network function in a core network, and receiving a report of an event from the radio access network node via the network function.

In another embodiment of the present application, an apparatus includes: at least one transmitter configured to send an event subscription for subscribing event reports from a radio access network node to a network function in a core network, and at least one receiver configured to receive a report of an event from the radio access network node via the network function.

According to an embodiment of the present application, a method includes: receiving an event report subscription from a network function in a core network, and sending an event container including a plurality of event reports in a predefined time. The plurality of event reports can report events associated with the event report subscription.

According to another embodiment of the present application, an apparatus includes: a receiver configured to receive an event report subscription from a network function in a core network, and a transmitter configured to send an event container including a plurality of event reports in a predefined time. The plurality of event reports can report events associated with the event report subscription.

Embodiments according to the present application provide practical solution for RAN event report transmission between RAN nodes and NWDAF, which can facilitate the development of the new generation wireless communication.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only example embodiments of the present application and are not therefore to be considered as limiting of its scope.

FIG. 1 illustrates an application scenario involving RAN event report transmission and network optimization according to an embodiment of the present application;

FIG. 2 illustrates a RAN event report transmission procedure according to an embodiment of the present application;

FIG. 3 illustrates an application scenario involving RAN event report transmission and network optimization according to another embodiment of the present application;

FIG. 4 illustrates a block diagram of RAN event report transmission system 400 according to an embodiment of the present application; and

FIG. 5 illustrates an application scenario involving RAN event report transmission and network optimization according to a further embodiment of the present application.

### DETAILED DESCRIPTION OF THE INVENTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

Although network optimization based on paging failure reports is introduced to the new generation wireless communication technology, numerous technical problems need to be solved to mature the solution. Wherein one key technical problem is how to report RAN (radio access network) events by a RAN node (which is also commonly called as “RAN”) to the NWDAF (network data analytics function). Considering the NWDAF is a centralized control plane function in a core network, it is not practical to propose a direct interface between the NWDAF and the RAN node. That is, the RAN node cannot directly report events to the NWDAF. Thus, RAN event report transmission between the NWDAF and the RAN node is a complex procedure.

Embodiments of the present application provide solutions can solve the above technical problems and provide technical solutions concerning RAN event report transmission and network optimization based on the analytics of RAN event reports.

According to an embodiment of the present application, the basic stages of a method for RAN event report transmission may be summarized as: sending an event report subscription to a radio access network node, receiving a report of an event associated with the event report subscription from the radio access network node, and transmitting the received report to a network data analytics function. In an example embodiment of the present application, this method can be implemented in a network function in a core network, for example, an AMF or a RECF (RAN event collection function).

According to another embodiment of the present application, the basic stages of a method for RAN event report transmission may be summarized as: sending an event subscription for subscribing event reports from a radio access network node to a network function in a core network, and receiving a report of an event from the radio access network node via the network function. In an example embodiment of the present application, this method can be implemented in an NWDAF.

According to a further embodiment of the present application, the basic stages of a method for RAN event report transmission may be summarized as: receiving an event report subscription from a network function in a core network, and sending an event container including a plurality of event reports in a predefined time. The plurality of event reports can report events associated with the event report subscription. In an example embodiment of the present application, this method can be implemented in a RAN node.

In addition, embodiments of the present application also provide an apparatus for RAN event report transmission.

According to an embodiment of the present application, the basic structure of the apparatus can be summarized as: at least one transmitter and at least one receiver. The at least one transmitter and the at least one receiver are configured to: send an event report subscription to a radio access network node via the at least one transmitter, receive a report of an event in response to the event report subscription from the radio access network node via the at least one receiver, and transmit the received report to a network data analytics function via the at least one transmitter. In an example embodiment of the present application, the apparatus can be a network function in a core network, for example, an AMF or a RECF.

According to another embodiment of the present application, the basic structure of the apparatus can be summarized as: at least one transmitter configured to send an event subscription for subscribing event reports from a radio access network node to a network function in a core network, and at least one receiver configured to receive a report of an event from the radio access network node via the network function. In an example embodiment of the present application, the apparatus can be an NWDAF.

According to a further embodiment of the present application, the basic structure of the apparatus can be summarized as: a receiver configured to receive an event report subscription from a network function in a core network, and a transmitter configured to send an event container including a plurality of event reports in a predefined time. The plurality of event reports can report events associated with the event report subscription. In an example embodiment of the present application, the apparatus can be a RAN node.

More details on the embodiments of the present application will be illustrated in the following text in combination with the appended drawings.

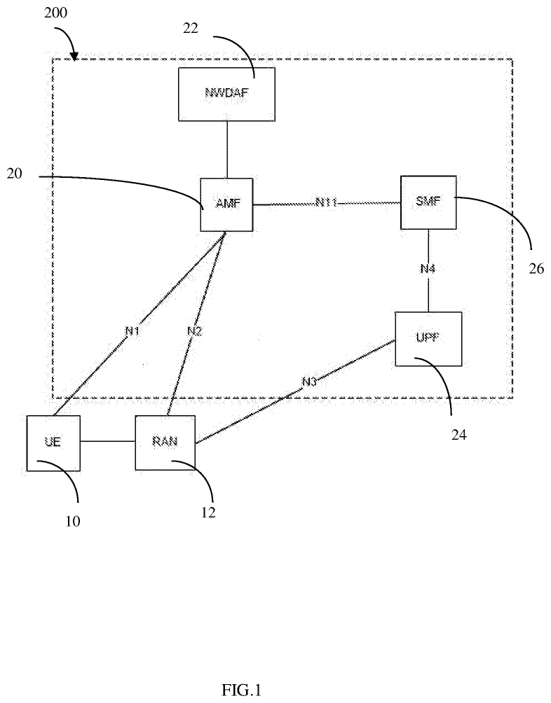

FIG. 1 illustrates an application scenario involving RAN event report transmission and network optimization according to an embodiment of the present application. Wherein, an UE (user equipment) 10 and a RAN node 12 are communicatively connected to a core network 200 including a plurality of network functions, such as AMFs 20 and NWDAF 22. Although only one UE 10, one RAN node 12 and one element for each type of network function in the core network 200 are shown in FIG. 1 for illustrating the principle of the present application in a clear and concise manner, persons skilled in the art know that in a real communication system, there can be more than one UE 10, RAN node 12 and network function, and can clearly determine their relationship and how they operate based on the disclosure and teaching of the embodiment of the present application (the same hereafter).

As shown in FIG. 1, in an example wireless communication system, the UE 10 is configured to communicably connect with the RAN node 12 (which is shown as “RAN,” hereafter the same) and the AMF 20 so that it can be served by the RAN node 12 and AMF 20, wherein the interface between the UE 10 and AMF 20 is N1. The RAN node 12, for example, a base station, is configured to communicably connect with the AMF 20 via an N2 interface and a UPF (user plane function) 24 in the core network 200 via an N3 interface. The AMF 20 is configured to communicably connect with the NWDAF 22 and a SMF (session management function) 26. The NWDAF 22 is a control plane function in the core network 200. The interface between the AMF 20 and SMF 26 is N11. The UPF 24 and SMF 26 are communicably connected with each other via an N4 interface.

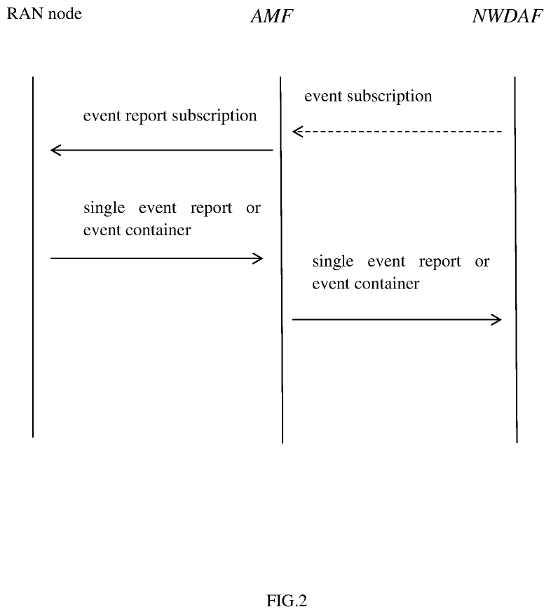

FIG. 2 illustrates a RAN event report transmission procedure according to an embodiment of the present application. The RAN event transmission procedure can be performed at least under the application scenario illustrated in FIG. 1.

As shown in FIG. 2, the NWDAF 22 can send an event subscription for subscribing event reports from the RAN node 12 to a network function in the core network 200. In an example embodiment, the network function can be the AMF 20 in the core network 200. Although only one AMF 20 is shown in FIG. 1, according to an embodiment of the present application, the NWDAF 22 can send the event subscription to one or more AMFs 20.

Accordingly, the AMF 20 can receive the event subscription from the NWDAF 22. In response to the received event subscription, the AMF 20 can send an event report subscription to the RAN node 12 via the N2 interface. In the case that more than one AMF 20 receive the event subscription, all of them can send the event report subscription to the RAN node 12. In another embodiment of the present application, the AMF 20 can send an event report subscription to the RAN node 12 on its own initiative without the event subscription from the NWDAF 22. Although the term “subscription” is used herein, it should not be limit to the specific manner of “subscription” provided in related communication specifications and protocols. Persons skilled in the art should know it can be implemented in other communication manners, such as “request” etc.

After receiving the event report subscription, the RAN node 12 can report events to the AMF 20 in a real time manner. For example, in an embodiment of the present application, the RAN node 12 can instantaneously send an event report to the AMF 20 upon the event happened. Specifically, the RAN node 12 can record at least one of: the identity of the NWDAF 22 which may be indicated in the event report subscription, the identity of the UE 10 associated with the event or an identity of a group of UEs 10 associated with the event, time when the event happens and an area associated with the event. Then, the RAN node 12 can send the related information to the AMF 20. The AMF 20 can be in active connection with the RAN node 12 and be serving the UE 10 associated with the happened event.

In some embodiments of the present application, the RAN node 12 can report events to the AMF 20 in predefined or required time, which can be set based on operator policy or local configuration etc. That is, the RAN node 12 does not report each event in a real time manner. Specifically, for each event, the RAN node 12 can record at least one of: the identity of the NWDAF 22, the identity of the UE 10 associated with the event, the identity of a group of UEs 10 associated with the event, time when the event happens and an area associated with the event. The RAN node 12 can merge a plurality of event reports into an event container, and send the plurality of event reports in a manner of event container to the AMF 20. The event reports within the event container can be associated with the same UE 10 or associated with different UEs 10. The RAN node 12 can choose any one of AMFs 20 which the RAN node can establish connection with.

For each event in the event container, the event container can indicate the type of the event, the identity of the UE 10 associated with the event or the identity of a group of UEs 10 associated with the event, time when the event happens and an area associated with the event. Table 1 illustrates an example of an event container according to an embodiment of the present application as following, wherein item “Event ID” means the type of each event, item “UE identity” means an identity of an UE 10 associated with the event, item “event time” means time when the event happens, item “Area” means an area associated with the event, and “RNA” means “RAN Notification Area” defined for UEs in RRC inactive state.

TABLE 1

| Event ID | UE identity | Event time | Area |
|---|---|---|---|
| RAN paging failure | UE ID 1 | 10:05 am | RNA 1 |
| RAN paging failure | UE ID 2 | 11:34 am | RNA 2 |
| RAN paging failure | UE ID 3 | 3:23 pm | RNA 3 |

As shown in Table 1, all the RAN events are RAN paging failure, happening in different UEs 10 and different time, and the three UEs 10 are within different RAN Notification Areas.

Accordingly, the AMF 20 can receive the event report from the RAN node 12, which can be single or included in the event container. Then, the AMF 20 can transmit/forward the received report to the NWDAF 22. Similarly, according to an embodiment of the present application, the AMF 20 can forward the event report to the NWDAF 22 upon receiving the event report. According to another embodiment of the present application, the AMF 20 can forward the received report to the NWDAF 22 in predefined or required time, which can be set based on operator policy or local configuration etc. For the event report, which is associated with the UE 10 that the AMF 20 is serving, the AMF 20 may check the event report and make corresponding operation. While for the received event container, it is transparent for the AMF 20. The AMF 20 only forwards the event container to the NWDAF 22. Anyway, the NWDAF 22 can receive the event report from the RAN node 12 via the AMF 20.

In some embodiments of the present application, the role of the AMF 20 playing in the RAN event report transmission, i.e., acting as an RAN event interface between the RAN node 12 and the NWDAF 22, can be replaced by other network functions within the core work 200, such as an OAM (operation administration and maintenance), and a RECF (RAN event collection function).

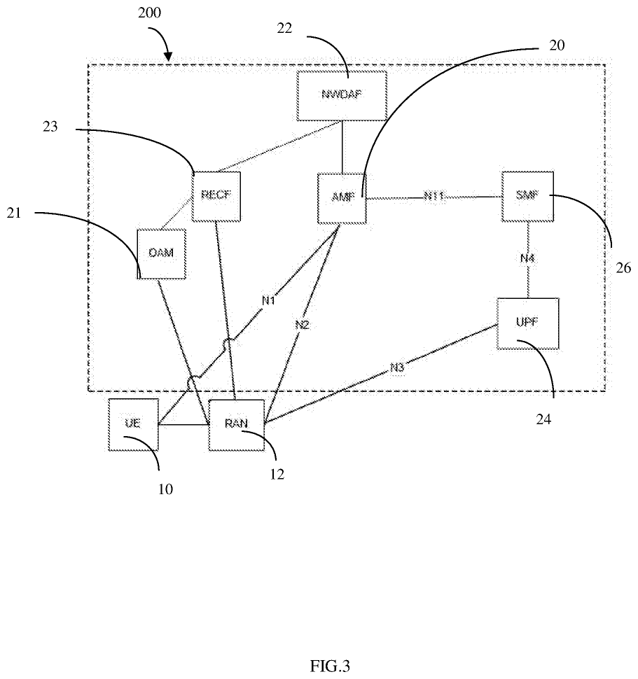

FIG. 3 illustrates an application scenario involving RAN event report transmission and network optimization according to another embodiment of the present application. Wherein, an UE 10 and a RAN node 12 are communicatively connected to a core network 200 including a plurality of network functions, such as AMFs 20 and NWDAF 22.

As shown in FIG. 3, in an example wireless communication system, the UE 10 is configured to communicably connect with the RAN node 12, and the RAN node 12 chooses the AMF 20 for the UE 10, so that the UE 10 can be served by the RAN node 12 and AMF 20. The N1 interface is used for transmitting NAS (Non-access Stratum) message between UE 10 and AMF 20. The RAN node 12, for example, a base station, is configured to communicably connect with the AMF 20 via an N2 interface and a UPF 24 via an N3 interface. The AMF 20 is configured to communicably connect with the NWDAF 22 and a SMF 26. The NWDAF 22 is a control plane function in the core network 200. The interface between the AMF 20 and SMF 26 is N11. The UPF 24 and SMF 26 are communicably connected with each other via an N4 interface.

In addition, the RAN node 12 can communicably connect with the OAM 21 or RECF 23. The RECF 23 can be collocated with the AMF 20, or deployed as one of the functions or services of the AMF 20. In some embodiments of the present application, the RECF 23 can be collocated with the OAM 21 or can be a standalone network function within the core network 200.

According to an embodiment of the present application, the RECF 23 can implement all operations associated with the event report transmission identical with that made by the AMF 20 recited above in view of FIG. 2. For example, the RECF 23 can send an event report subscription to the RAN node 12, which can be made in response to receiving an event subscription from the NWDAF 22 or on its own initiative. The RECF 23 can receive a report of an event associated with the event report subscription from the RAN node 12. The RECF 23 can transmit the received report to other network functions, e.g. the NWDAF 22.

In an embodiment of the present application, the OAM 21 can receive RAN event reports from the RAN node 12. The OAM 21 can directly forward them to the NWDAF 22 or forward them to the RECF 23. The RECF 23 can further forward the RAN event reports received from the OAM 21 to the NWDAF 22.

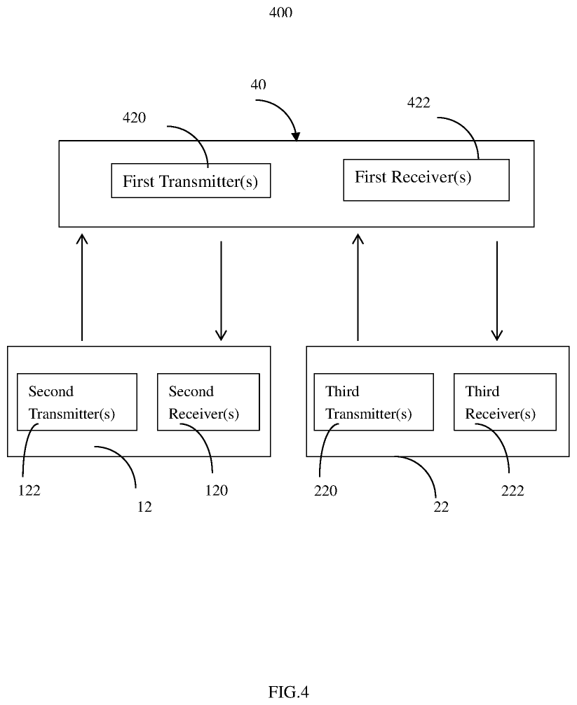

FIG. 4 illustrates a block diagram of RAN event report transmission system 400 according to an embodiment of the present application. The RAN event report transmission system 100 can at least operate under the application scenario illustrated in FIG. 1 and FIG. 3, and can at least perform the transmission procedure illustrated in FIG. 2.

As shown in FIG. 4, the RAN event report transmission system 100 according to an embodiment of the present application can at least include a RAN node 12, a NWDAF 22, and a network function 40 acting as the interface between the RAN node 12 and the NWDAF 22. The network function 40 can be the AMF 20, the RECF 23 or other adaptable network function within the core network 20.

Specifically, in an embodiment of the present application, the network function 40 acting as the interface can include at least one first transmitter 420 and at least one first receiver 422. The at least one first transmitter 420 and the at least one first receiver 422 are configured to: send an event report subscription to the RAN node 12 via the at least one first transmitter 420, receive a report of an event in response to the event report subscription from the RAN node 12 via the at least one first receiver 422, and transmit the received report to the NWDAF 22 via the at least one first transmitter 420. According to an embodiment of the present application, the at least one first receiver 422 can receive an event subscription from the NWDAF 22, and the event report subscription can be made in response to the event subscription.

In an embodiment of the present application, the RAN node 12 can include a second receiver 120 configured to receive the event report subscription from the network function 40 in the core network 200, for example, the AMF 20; and a second transmitter 122 configured to send an event report in response to the event report subscription. The event report can be sent in single or included in an event container including a plurality of event reports. The RAN node 12 can send the event report(s) in real time manner or in a predefined/required time set based on operator policy or local configuration etc.

In an embodiment of the present application, the NWDAF 22 can include at least one third transmitter 220 configured to send an event subscription for subscribing event reports from the RAN node 12 to the network function 40 in the core network 20, and at least one third receiver 222 configured to receive a report of an event from the RAN node 12 via the network function 40.

Based on the RAN event reports, the NWDAF 22 can perform various control functions. For example, based on the received RAN event reports, especially, paging failure reports, the NWDAF 22 can decide whether to generate an alert message to indicate at least one related network function to perform network optimization based on the alert message.

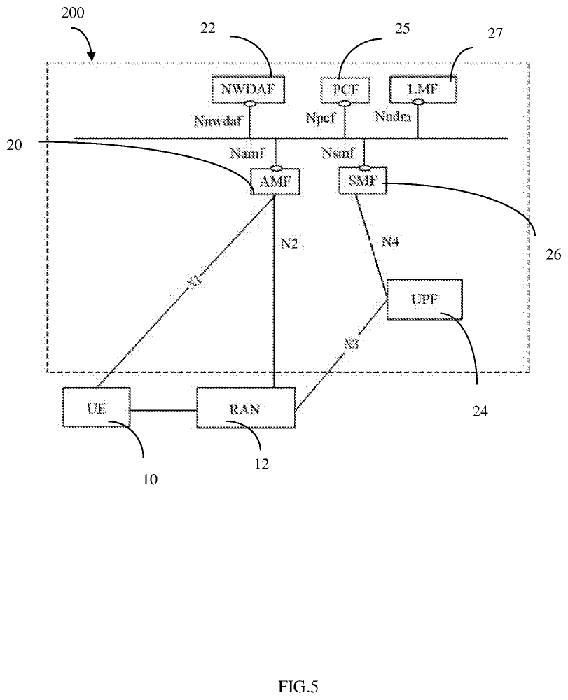

FIG. 5 illustrates an application scenario involving RAN event report transmission and network optimization according to a further embodiment of the present application. Wherein, an UE 10 and a RAN node 12 are communicatively connected to a core network 200 including a plurality of network functions, such as AMFs 20 and NWDAF 22.

As shown in FIG. 5, in an example wireless communication system, the UE 10 is configured to communicably connect with the RAN node 12, and the RAN node 12 chooses the AMF 20 for UE 10, so that UE 10 can be served by the RAN node 12 and AMF 20. The N1 interface is used for transmitting NAS message between UE 10 and AMF 20. The RAN node 12, for example, a base station, is configured to communicably connect with the AMF 20 via an N2 interface and the UPF 24 via an N3 interface. The AMF 20, the NWDAF 22, a PCF (policy control function) 25, a LMF (location management function) 27 and the SMF 26 are configured to be communicably connected via corresponding interfaces, such as Nmaf, Nsmf, Nnwdaf, Npcf and Nudm etc. The NWDAF 22 is a plane function in the core network 200. The UPF 24 and SMF 26 are communicably connected with each other via an N4 interface.

In an embodiment of the present application, based on the received paging failure reports, the NWDAF 22 may find that the paging failure rate for a certain area and at certain time is higher than a threshold set by the operator. In this case, the NWDAF 22 can generate an alert message for network optimization and send the alert message to related network function (s) to perform network optimization based on the alert message.

According to an embodiment of the present application, the NWDAF 22 can send the alert message to the AMF 20 serving the associated area indicated in the alert message. The alert message can include at least one of the possible paging failure area and possible paging failure time. The alert message can also include the identity of UE 10 or the identity of group of UEs 10.

According to an embodiment of the present application, the AMF 20 can include at least one processor (not shown) according to an embodiment of the present application. In the case that the AMF 20 receives an alert message for network optimization from the NWDAF 22, the at least one processor can be configured to perform the network optimization based on the alert message.

In an embodiment of the present application, the AMF 20 can perform at least one of the following optimization operations, for example by the at least one processor: adjusting the Periodic Registration timer for a UE 10 or a group of UEs 10 being served by the AMF 20; adjusting the Mobile Reachable timer and an Implicit Deregistration timer for a UE 10 or a group of UEs 10 being served by the AMF 20; sending a N11 message to the SMF 26 for a UE 10 or a group of UEs 10 being served by the AMF 20 so that the SMF 26 can adjust buffering timers for the corresponding UE 10 or UE group; and initiating a Network Triggered Service Request procedure for 3GPP access via non-3GPP access in response to that a UE 10 is in CM-IDLE state in 3GPP access and in CM-CONNECTED state in non-3GPP access, wherein the UE 10 is simultaneously registered over 3GPP and non-3GPP accesses in the same PLMN (public land mobile network).

According to another embodiment of the present application, the NWDAF 22 can send the alert message to the OAM 21. The alert message can include at least one of the possible paging failure area and possible paging failure time. The Alert message can also include one of the identity of UE and the identity of group of UEs.

According to an embodiment of the present application, the OAM 21 may analyze whether to optimize the network radio coverage based on the paging failure alert message. Alternatively, the OAM may further identify the coverage hole based on the paging failure alert message.

According to a further embodiment of the present application, the NWDAF 22 can send the alert message to the PCF 25. The alert message can include at least one of the possible paging failure area, for example the identity of related AMF 20 and possible paging failure time. The alert message can also include one of the identity of UE 10 and the identity of group of UEs 10. The PCF 25 can update URSP (UE route selection policy) rules for the UE 10 or the group of UEs 10 within the area indicated in the alert message. For example, the Access Type Preference in the route selection descriptor may be changed to non-3GPP access.

According to yet another embodiment of the present application, the NWDAF 22 can send the alert message to the LMF 27. The alert message can include at least one of the possible paging failure area, for example the identity of related AMF 20 and possible paging failure time. The alert message can also include one of the identity of UE 10 and the identity of group of UEs 10. The LMF 27 can initiate MT (mobile terminated) location request procedure in non-3GPP access for a UE 10 within the area indicated in the alter message in response that the UE is in CM-IDLE state in 3GPP access and in CM-CONNECTED state in non-3GPP access, wherein the UE is simultaneously registered over 3GPP and non-3GPP accesses in the same PLMN, and the non-3GPP access can satisfy the QOS (quality of service) of the location requirement.

According to some embodiments of the present application, the method of this disclosure can be implemented on at least one programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which there resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be capable of making and using the teachings of the present application by simply employing the elements of the independent claims. Accordingly, the embodiments of the present application as set forth herein are intended to be illustrative, not limiting. Various changes may be made without departing from the spirit and scope of the present application.

In this document, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “including.”

1. A method, comprising:
sending an event report subscription to a radio access network node;
receiving a report of an event associated with the event report subscription from the radio access network node; and
transmitting the received report to a network data analytics function.

2. The method of claim 1, comprising receiving an event subscription from the network data analytics function, wherein the event report subscription is made in response to the event subscription.

3. The method of claim 1, wherein the received report is within an event container, wherein for each event in the event container, the event container indicates a type of the event, an identity of a user equipment associated with the event or an identity of a group of user equipment associated with the event, time when the event happens and an area associated with the event.

4. The method of claim 1, wherein the received report includes at least one of an identity of the network data analytics function, an identity of a user equipment associated with the event, an identity of a group of user equipment associated with the event, time when the event happens and an area associated with the event.

5. The method of claim 1, wherein the event is a paging failure.

6. The method of claim 1, wherein the event is a paging failure, and the method comprises receiving an alert message for network optimization from the network data analytics function and performing the network optimization based on the alert message.

7. The method of claim 6, wherein the network optimization is performed by an access management function, and the access management function performs at least one of the following:
adjusting the Periodic Registration timer for a user equipment or a group of user equipment being served by the access management function;
adjusting the Mobile Reachable timer and an Implicit Deregistration timer for a user equipment or a group of user equipment being served by the access management function;
sending a N11 message to a session management function for a user equipment or a group of user equipment being served by the access management function; and
initiating a Network Triggered Service Request procedure for 3rd generation partnership project access via non-3rd generation partnership project access in response to that a user equipment is in CM-IDLE state in 3rd generation partnership project access and in CM-CONNECTED state in non-3rd generation partnership project access, wherein the user equipment is simultaneously registered over 3rd generation partnership project and non-3rd generation partnership project accesses in the same public land mobile network.

8. (canceled)

9. (canceled)

10. (canceled)

11. (canceled)

12. (canceled)

13. (canceled)

14. (canceled)

15. (canceled)

16. (canceled)

17. A method, comprising:
sending an event subscription for subscribing event reports from a radio access network node to a network function in a core network; and
receiving a report of an event from the radio access network node via the network function.

18. The method of claim 17, wherein the event is a paging failure, and the method comprises sending an alert message to the network function so that the network function can perform network optimization based on the alert message.

19. The method of claim 17, wherein the network function is one of an access management function and a radio access network event collection function.

20. The method of claim 18, wherein the network function is an access management function, and the access management function performs at least one of the following:
adjusting the Periodic Registration timer for a user equipment or a group of user equipment being served by the access management function;
adjusting the Mobile Reachable timer and an Implicit Deregistration timer for a user equipment or a group of user equipment being served by the access management function;
sending a N11 message to session management function for a user equipment or a group of user equipment being served by the access management function; and
initiating a Network Triggered Service Request procedure for 3rd generation partnership project access via non-3rd generation partnership project access in response to that a user equipment is in CM-IDLE state in 3rd generation partnership project access and in CM-CONNECTED state in non-3rd generation partnership project access, wherein the user equipment is simultaneously registered over 3rd generation partnership project and non-3rd generation partnership project accesses in the same public land mobile network.

21. The method of claim 18, wherein the event is a paging failure, and the method comprises sending an alert message for network optimization to a further network function in the core network so that the further network function can perform the network optimization based on the alert message.

22. The method of claim 21, wherein the further network function is one of an access management function, an operation administration and maintenance, a policy control function and a location management function.

23. The method of claim 22, wherein the policy control function is configured to update UE route selection policy rules for a user equipment or a group of user equipment within the area indicated in the alert message.

24. The method of claim 22, wherein the location management function is configured to initiate MT location request procedure in non-3rd generation partnership project access for a user equipment within the area indicated in the alter message in response that the user equipment is in CM-IDLE state in 3rd generation partnership project access and in CM-CONNECTED state in non-3rd generation partnership project access, wherein the UE is simultaneously registered over 3rd generation partnership project and non-3rd generation partnership project accesses in the same public land mobile network, and the non-3rd generation partnership project access can satisfy the quality of service of the location management function.

25. (canceled)

26. (canceled)

27. (canceled)

28. (canceled)

29. (canceled)

30. A method, comprising:
receiving an event report subscription from a network function in a core network; and
sending an event container including a plurality of event reports in a predefined time, wherein the plurality of event reports report events associated with the event report subscription.

31. The method of claim 30, wherein for each event in the event container, the event container indicates a type of the event, an identity of a user equipment associated with the event or an identity of a group of user equipment associated with the event, time when the event happens and an area associated with the event.

32. The method of claim 30, wherein the event associated with the event report subscription is a paging failure.

33. The method of claim 30, wherein the network function is one of an access management function and an radio access network event collection function.

34. (canceled)

35. (canceled)

36. (canceled)

37. (canceled)
